(19) United States
(12) Patent Application Publication
(10) Pub. No.: US 2012/0130663 A1
(43) Pub. Date: May 24, 2012

(54) ON-LINE DIAGNOSTIC METHOD FOR HEALTH MONITORING OF A TRANSFORMER

(75) Inventors: Joshi Prasad Madhukar, Maharashtra (IN); Kulkarni Shrikrishna Vyankatesh, Maharashtra (IN)

(73) Assignee: INDIAN INSTITUTE OF TECHNOLOGY, BOMBAY, Powai, Mumbai (IN)

(21) Appl. No.: 13/386,517

(22) PCT Filed: Jul. 15, 2010
(86) PCT No.: PCT/IN2010/000474

§ 371 Date: Jan. 23, 2012

(30) Foreign Application Priority Data
Jul. 23, 2009 (IN) 1700/MUM/2009

(51) Int. Cl. G06F 19/00; G01N 27/22

(52) U.S. Cl. 702/65

(57) ABSTRACT

An on-line diagnostic method for health monitoring of a transformer. In the case of a single phase or three phase star connected transformer deformations in the winding are determined by

representing the transformer winding as a lumped parameter circuit and dividing the winding into at least two sections. A first set of fingerprint values are generated to determine the location of the deformed section of the winding and the type of deformation. A second set of finger print values are generated to determine the extent of deformation of the deformed section. The location and extent of radial or axial deformation or combination of both radial and axial deformation in the winding are then determined. The change in the capacitance of the bushing of the transformer connected at the line end of the winding is also determined. The state of the insulation system of the transformer is determined by detecting partial discharge pulses in the transformer winding. The change in the dielectric characteristics of the insulation system of the transformer is detected on the basis of phase angle difference.

### FIELD OF THE INVENTION

This invention relates to an on-line diagnostic method for health monitoring of a transformer.

### BACKGROUND OF THE INVENTION

Transformers are used to step up or step down voltage levels in power systems and are important components of power systems. Health monitoring of transformers is extremely important to ensure smooth and efficient operation of the transformers and to prevent damage and breakdown of the transformers. Several causative factors like deformations in the transformer winding (high voltage or HV winding or low voltage or LV winding), change in capacitance of the bushing of the transformer or deteriorations in the insulation system of the transformer due to partial discharges or change in dielectric strength can reduce the performance efficiency of the transformer and cause damage and breakdown of the transformer. Frequency Response Analysis (FRA) is a widely used method for detection of deformations in the transformer winding (Secue, J. R. and Momembello E., “Sweep frequency response analysis (SFRA) for the assessment of winding displacements and deformation in power transformers,” Electrical Power System Research, vol. 78, 2008, pp. 1119-1128.) In this method, the sweep frequency response of the winding is obtained as a fingerprint graph. At the time of detection of deformations in the winding, a set of measurements are again made to obtain frequency response. The graph representing the subsequent measurements is superimposed on the fingerprint graph and the differences, if any, between the curves of the two graphs are examined for deformations. Examination/analysis of the differences between the two graphs is subjective and may vary from person to person and may not provide a proper and accurate evaluation of the deformations. Further, differences between the two graphs will only indicate presence of deformation, if any, but will not indicate the location, nature and extent of the deformation straightaway. In our patent application No 1893/MUM/2007 we have described a method for determining deformations in a transformer winding in an accurate and reliable manner. One method for measuring changes in capacitance of transformer bushing is based on measuring its power factor on-line using sensors on the bushing capacitance taps to measure leakage currents. Another technique for determining change in the bushing capacitance of three phase transformers, sums up the bushing currents from the three phases and plots them on a polar plot. Any shift in the resultant currents indicates a change in capacitance or dissipation factor of one of the bushings (IEEE Standard-62, 1995). Acoustic method is used for detecting partial discharges (PD) in the transformer. This method comprises sensing mechanical vibrations generated by PD pulses using acoustic sensors mounted either on the transformer tank wall or in the oil inside the transformer tank. If multiple sensors are used, the PD can be located based on the arrival time of the pulses at the sensors (IEEE Standard C57.113-1991, Revised 2002). The sensitivity of the test is dependent on the location of the PD since the signal is attenuated by the oil and winding structure. PD is also known to be detected indirectly using chemical techniques involving measurement of degradation products produced by the PD. Such techniques do not give any information about location of PD. PD causes high-frequency low-amplitude disturbances on the current waveforms, which can be detected electrically. The electrical PD signals are measured in bushing tap current and neutral current. Another technique applied to detect PD in gas insulated substations is based on ultra-high-frequency (UHF) signals (typically 1-2 GHz). Methods like dielectric breakdown test, moisture content test, dissolved gas analysis (DGA) test or power factor test are used for determining the dielectric strength and status of the insulation system of the transformer (IEEE Standard C57.104, 1991).

### OBJECTS OF THE INVENTION

An object of the invention is to provide an on-line diagnostic method for health monitoring of a transformer, which method continuously monitors multiple health factors of the transformer in service condition without having to isolate the transformer from the power system in which it is connected so as to give a comprehensive health status of the transformer.

Another object of the invention is to provide an on-line diagnostic method for health monitoring of a transformer, which method is accurate and reliable and effective in determining the health factors of the transformer.

Another object of the invention is to provide an on-line diagnostic method for health monitoring of a transformer, which method eliminates the down time required for the diagnosis of the health condition of the transformer.

Another object of the invention is to provide an on-line diagnostic method for health monitoring of a transformer, which method can help to understand the dynamic behaviour of the transformer subjected to short circuit.

Another object of the invention is to provide an on-line diagnostic method for health monitoring of a transformer, which method is simple and easy to carry out and is economical.

### DETAILED DESCRIPTION OF THE INVENTION

According to the invention there is provided an on-line diagnostic method for health monitoring of a single phase transformer or a three phase star connected transformer, the method comprising the following steps:

A) determining deformations in the transformer winding by

A-1) representing the transformer winding as a lumped parameter circuit and dividing the winding into at least two sections n;

A-2) generating a first set of fingerprint values by
(i) measuring the high frequency terminal current I₁ at one end of the winding when a constant sinusoidal voltage V₁ is applied between one end of the winding and one ground terminal at a high frequency in a band of frequencies at which the terminal impedance of the winding remains capacitive, while keeping the other end of the winding and the other ground terminal connected; measuring the high frequency terminal current I₂ flowing from other end of the winding to the other ground terminal at the same high frequency, while keeping the same voltage V₁ between one end of the winding and the one ground terminal; and measuring the phase angle θ₁ between I₁ and V₁, the application of high frequency voltage and detection of high frequency currents being carried out by employing known procedures of coupling and detecting such signals superimposed on power frequency voltage/current components;
ii) calculating the sectional series capacitance (Cₛ) and the sectional ground capacitance (C_{g}) of each of the different sections n of the winding using the values of I₁, I₂ and V₁ obtained in step A-2(i) and the value of bushing capacitance C_{b} provided by the transformer manufacturer as follows:

$$I = {I}_{1} - ω {C}_{b} {V}_{1}$$

$$N = {[ \begin{matrix}\frac{I}{{I}_{2}} & \frac{ω {V}_{1}}{{I}_{2}} \\ \frac{( {I}^{2} - {I}_{2}^{2} )}{ω {V}_{1} {I}_{2}} & \frac{I}{{I}_{2}}\end{matrix} ]}^{\frac{1}{n}}$$

$${C}_{s} = \frac{1}{N ( 1 , 2 )}$$

$${C}_{g} = 2 [ {C}_{s} N ( 1 , 1 ) - {C}_{s} ]$$

where ω is the selected high frequency in rad/sec,
   n is number of sections,
   N is 2×2 matrix obtained from measurements in step A-2(i) and
   N(1,1) and N(1,2) are the first and second element of row one of matrix N,
   V₁ is constant sinusoidal voltage applied in volts, and
   I₁ and I₂ are two terminal currents in amperes
(iii) simulating a range of deformations in each of the sections of the winding by changing the sectional ground capacitance C_{g} and sectional series capacitance Cₛ obtained in step A-2(ii) by predetermined percentages and generating simulated terminal current values I₁¹ and I₂¹ under the same conditions and procedures corresponding to I₁ and I₂, respectively in step A-2(i) for each change of the sectional ground capacitance and sectional series capacitance;
(iv) calculating current deviation coefficient which is a non-limiting function of (I₁−I₁¹)/(I₂−I₂¹) for each of the sections of the winding for each change of the sectional ground capacitance C_{g} and the sectional series capacitance Cₛ obtained in step A-2(iii) to form a first look up table of current deviation coefficients; and forming a first set of finger print values using the current deviation coefficients, the first set of finger print values indicating the location of the deformed section of the winding and the type of deformation;

A-3) generating a second set of finger print values by calculating the difference between I₁ obtained in step A-2(i) and I₁¹ obtained in step A-2(iii) and between I₂ obtained in step A-2 (i) and I₂¹ obtained in step A-2 (iii) for each of the sections of the winding for each change of the sectional ground capacitance C_{g} and the sectional series capacitance Cₛ obtained in step A-2 (iii); forming a second lookup table of differences and forming a second set of finger print values using the differences, the second set of fingerprint values indicating the extent of deformation of the deformed section; and

A-4) determining the location and extent of radial or axial deformation or combination of both radial and axial deformation in the winding by
(i) measuring the terminal current values I₁¹¹ and I₂¹¹ as explained in step A-2(i) at the same high frequency voltage V₁;
(ii) comparing the values of I₁ with I₁¹¹ and I₂ with I₂¹¹, a no difference in the values indicating no deformation in the winding and a difference in the values indicating deformation in the winding, in which case carrying out the following steps:
(a) calculating the current deviation coefficient which is a non-limiting function of (I₁−I₁¹¹)/(I₂−I₂¹¹) for identifying the section of the winding which has been deformed; comparing the calculated current deviation coefficient with the first fingerprint values of current deviation coefficients obtained in step A-2(iv) for locating the section of the winding which has been deformed, the current deviation coefficient being always negative for radial deformation of a section and being always positive for axial deformation of a section, the sign of the current deviation being an indicator of the type of deformation; the sign of current deviation coefficient for combined axial and radial deformations depending on the dominating type (axial or radial) of deformation and being located with the first set of finger print values obtained in step A-2(iv).
(b) calculating the difference between I₁ and I₁¹¹ and between I₂ and I₂¹¹; comparing the difference of I₁−I₁¹¹ with the corresponding second set of fingerprint values of I₁−I₁¹ obtained in step A-3 and also the difference of I₂−I₂¹¹ with the corresponding second set of fingerprint values of I₂−I₂¹ obtained in step A-3 for the located section in step A-4(ii)(a) to give the extent of axial and radial deformation;

B) determining the change in the capacitance of the bushing of the transformer connected at the line end of the winding by
(i) measuring the terminal current values I₁¹¹¹ and I₂¹¹¹ as stated in step A-2(i) at the same high frequency voltage V₁;
(ii) comparing the values of I₁ with I₁¹¹¹ and I₂ with I₂¹¹¹; a no difference in the values of I₂ and I₂¹¹¹ and a difference between I₁ and I₁¹¹¹ indicating no deformation in the winding but a change in the bushing capacitance;
(iii) and if necessary determining the change in the bushing capacitance by finding out the difference between I₁ and I₁¹¹¹ and dividing the difference by ω V₁ to give the change in capacitance of the bushing; and

C) determining the state of the insulation system of the transformer by detecting partial discharge pulses in the transformer winding by

(a)
(i) switching off the high frequency signal and measuring and analyzing the current variation of the partial discharge pulses seen at line terminal of the winding and at the other terminal of the winding to get signals I₁¹¹¹¹ and I₂¹¹¹¹ by digitally filtering signals with the band pass filter whose frequency band is the same as the frequency band in which transformer winding behaves as capacitive network as stated in A-2(i); and
(ii) determining the ratio of I₁¹¹¹¹/I₂¹¹¹¹ to give the location of partial discharge pulses, a ratio greater than one indicating the location of partial discharge towards the line end of the winding, a ratio near or close to one, indicating the location of partial discharge near or close to the center of the winding and a ratio less than one indicating the location of partial discharge towards the other end of the winding; and

(b)

by detecting change in the dielectric characteristics of the insulation system of the transformer by
(i) measuring the θ₁¹¹ as described in step A-2(i) at the same high frequency voltage V₁; and
(ii) comparing the values of θ₁ obtained in step A-2(i) and θ₁¹¹ obtained in step C(b)(i), a substantial change in the values indicating change in the dielectric characteristics of the insulation system.

According to the invention there is also provided an on-line diagnostic method for health monitoring of a three phase delta connected transformer, the method comprising the following steps:

D) representing the three phase windings as P1, P2 and P3 and further representing one of the phase windings P1 as a lumped parameter circuit and dividing the phase winding P1 into at least two sections n;

E) generating a first set of fingerprint values by

(i) shorting under off-line condition both the ends of the phase winding P2 and connecting the shorted ends of the phase winding P2 to the ground terminal, measuring the injected high frequency terminal current I₃ at one end of the phase winding P1 when a constant sinusoidal voltage V₁ is applied between the said one end of the phase winding P1 and the ground terminal and measuring the high frequency terminal current I₄ between the shorted ends of the phase windings P2 and the ground terminal and disconnecting the short circuited ends of the phase winding P2; the high frequency being selected only once in a band of frequencies at which the terminal impedance of the winding remains capacitive;

(ii) measuring the high frequency terminal current I₁ at said one end of the phase winding P1 and current I₂ at other end of the phase winding P1 when a constant sinusoidal voltage V₁ is applied through coupling capacitors between one ends of the phase windings P1, P2 and P3 and ground terminal at the same high frequency, measuring the phase angle θ₁ between I₁ and V₁, the injection of high frequency current along with power line current being carried out by employing known procedures of coupling and detecting such signals superimposed on power frequency voltage/current components;

(iii) calculating the sectional series capacitance (Cₛ) and the sectional ground capacitance (C_{g}) of each of the sections n of the phase windings P1 using the values of I₃ and I₄ obtained in step E(i) and the value of bushing capacitance C_{b} provided by the transformer manufacturer as follows:

$$I = {I}_{3} - ω {C}_{b} {V}_{1}$$

$$N = {[ \begin{matrix}\frac{I}{{I}_{4}} & \frac{ω {V}_{1}}{{I}_{4}} \\ \frac{( {I}^{2} - {I}_{4}^{2} )}{ω {V}_{1} {I}_{4}} & \frac{I}{{I}_{4}}\end{matrix} ]}^{\frac{1}{n}}$$

$${C}_{s} = \frac{1}{2 N ( 1 , 2 )}$$

$${C}_{g} = 2 [ {C}_{s} N ( 1 , 1 ) - {C}_{s} ]$$

where ω is selected high frequency in rad/sec,
   n is number of sections,
   N is 2×2 matrix obtained from measurements in step E(i) and N(1,1) and N(1,2) are the first and second element of row one of matrix N,
   V₁ is constant sinusoidal voltage applied in volts and
   I₃ and I₄ are two terminal current in amperes

(iv) simulating a range of deformations in each of the sections n of phase winding P1 by changing the sectional ground capacitance C_{g} and sectional series capacitance Cₛ obtained in step E(iii) by predetermined percentages and generating simulated terminal current values I₁¹ and I₂¹ under the same conditions and procedures corresponding to I₁ and I₂, respectively in step E(ii) for each change of the sectional ground capacitance and sectional series capacitance;

(v) calculating current deviation coefficient which is a non-limiting function of (I_{I}−I₁¹)/(I₂−I₂¹) for each of the sections of the winding for each change of the sectional ground capacitance C_{g} obtained in step E(iii) and the sectional series capacitance Cₛ obtained in step E(iii); and forming a first set of finger print values using lookup table of the current deviation coefficients; and

(vi) calculating the difference (I₁−I₁¹) between I₁ obtained in step E(ii) and I₁¹ obtained in step E(iv) and also the difference (I₂−I₂¹) between I₂ obtained in step E(ii) and I₂¹ obtained in step E(iv) for each of the sections of the phase winding P1 for each change of the sectional ground capacitance C_{g} and the sectional series capacitance Cₛ obtained in step E(iii) and forming a second set of fingerprint values using the lookup table of the current differences, the second set of fingerprint values indicating the extent of deformation of the deformed section; and

F. representing each of the phase windings P2 and P3 as a lumped parameter circuit and dividing each of the phase windings P2 and P3 into at least two sections n and generating a first set of finger print values and a second set of finger print values for each of the remaining phase windings P2 and P3 as described in step (E), shorting of the ends of phase winding P3 is done for off-line measurement of phase winding P2 and shorting of the ends of phase winding P1 is done for off-line measurement of phase winding P3;

G) determining the location and extent of radial and/or axial deformation in the phase winding P1 by
(i) measuring the terminal current values I₁¹¹ and I₂¹¹ as explained in step E(ii) at the same high frequency voltage V₁;
(ii) comparing the values of I₁ with I₁¹¹ and I₂ with I₂¹¹, a no difference in the values indicating no deformation in the winding and a difference in the values indicating deformation in the winding, in which case carrying out the following further steps:
(a) calculating the current deviation coefficient which is a non-limiting function of (I₁−I₁¹¹)/(I₂−I₂¹¹) for identifying the section of the winding which has been deformed; comparing the calculated current deviation coefficient with the first fingerprint values of current deviation coefficients obtained in step E(v) for locating the section of the winding which has been deformed, the current deviation coefficient being always positive for radial deformation of a section and being always negative for axial deformation of a section, the sign of the current deviation being an indicator of the type of deformation; the sign of current deviation coefficient for combined axial and radial deformations depending on the dominating type (axial or radial) of deformation and being located with the first of finger print values obtained in step E(v);
(b) calculating the difference between I₁ and I₁¹¹ and between I₂ and I₂¹¹; comparing the difference of I₁−I₁¹¹ with the corresponding second set of fingerprint values of I₁−I₁¹ obtained in step E(vi) and also the difference of I₂−I₂¹¹ with the corresponding second set of fingerprint values of I₂−I₂¹ obtained in step E(vi) for the located section in step G(ii)(a) to give the extent of deformation;

H) repeating the above procedure for determining the location and extent of radial and/or axial deformation in the other phase windings P2 and P3;

I) determining the change in the capacitance of the bushing of the transformer connected at the line end of each of the phase windings P1, P2 and P3 by
(i) measuring the terminal current values I₁¹¹¹ and I₂¹¹¹ as stated in step E(ii) at the same high frequency voltage V₁;
(ii) comparing the values of I₁ with I₁¹¹¹ and I₂ with I₂¹¹¹; a no difference in the values of I₂ and I₂¹¹¹ and a difference between I₁ and I₁¹¹¹ indicating no deformation in the winding but a change in the bushing capacitance;
(iii) and if necessary determining the change in the bushing capacitance by finding out the difference between I₁ and I₁¹¹¹ and dividing the difference by ω V₁ to give the change in capacitance of the bushing; and

J) determining the state of the insulation system of the transformer:

(a) by detecting partial discharge pulses in each of the phase windings P1, P2 and P3 by
(i) switching off the high frequency signal and measuring and analyzing the current variation of the partial discharge pulses seen at line terminal of the phase winding and at the other terminal of the phase winding to get signals I₁¹¹¹¹ and I₂¹¹¹¹ by digitally filtering signals with the band pass filter whose frequency band is the same as the frequency band in which transformer winding behaves as capacitive network as stated in step E(i); and
(ii) determining the ratio of I₁¹¹¹¹/I₂¹¹¹¹ to give the location of partial discharge pulses, a ratio greater than one indicating the location of partial discharge towards the line end of the winding, a ratio near or close to one, indicating the location of partial discharge near or close to the center of the phase winding and a ratio less than one indicating the location of partial discharge towards the other end of the phase winding; and

(b) by detecting change in the dielectric characteristics of the insulation system of the transformer by
(i) measuring the θ₁¹¹ as described in step E(ii) at the same high frequency voltage V₁; and
(ii) comparing the values of θ₁ in step E(ii) and θ₁¹¹ in step J(b)(i), a substantial change in the values indicating change in the dielectric characteristics of the insulation system.

The following is a detailed description of the invention with reference to the accompanying drawings, in which:

FIG. 1 is a lumped parameter circuit representation of a single phase transformer winding;

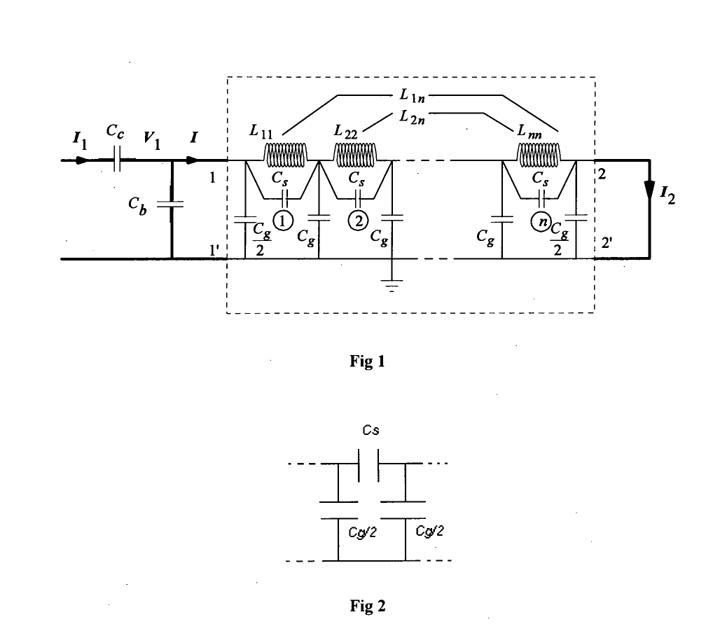

FIG. 2 is a pi (Π) model representation of each section of the transformer winding of FIG. 1 at the selected high frequency;

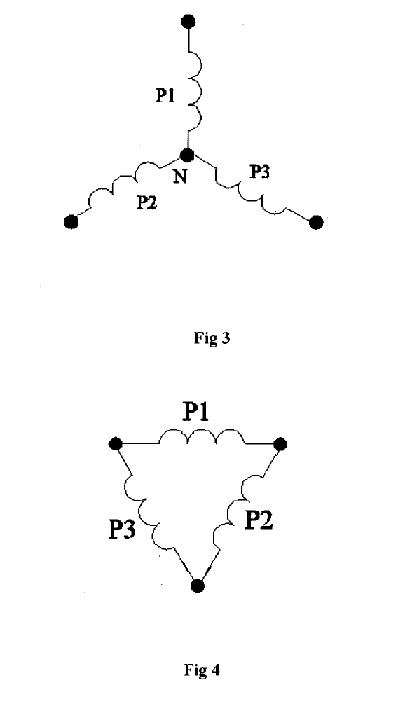

FIG. 3 is a representation of the three phase windings of a three phase transformer connected in star configuration; and

FIG. 4 is a representation of the three phase windings of a three phase transformer connected in delta configuration.

In FIG. 1 of the accompanying drawings, the transformer winding is represented as a lumped parameter circuit and the winding is divided into different uniform sections n. Each section of the transformer winding comprises elements like series capacitance (Cₛ), self inductance (Lᵢᵢ), mutual inductance (Lᵢⱼ), i and j standing for 1 to n and ground capacitance (C_{g}). The bushing capacitance C_{b} and the coupling capacitor C_{c} are also shown in FIG. 1. V₁ is the applied high frequency voltage. I₁ is the high frequency current drawn from source, I is high frequency current going into the winding at one end of the winding, I₂ is the high frequency current going out the winding to ground at other end of the winding. Each section of the winding is represented by a pi (Π) model at the selected high frequency as illustrated in FIG. 2 of the accompanying drawings, in which two legs are given by C_{g}/2.

According to the method of the invention, deformation in the transformer winding of FIGS. 1 and 2 is determined by generating a first set of fingerprint values by
(i) measuring the high frequency terminal current I₁ at one end of the winding when a constant sinusoidal voltage V₁ is applied between one end of the winding and one ground terminal at a high frequency in a band of frequencies at which the terminal impedance of the winding remains capacitive, while keeping the other end of the winding and the other ground terminal connected; measuring the high frequency terminal current I₂ flowing from other end of the winding to the other ground terminal at the same high frequency, while keeping the same voltage V₁ between one end of the winding and the one ground terminal and measuring the phase angle θ₁ between I₁ and V₁; wherein the application of high frequency voltage and detection of high frequency currents being carried out by employing known procedures of coupling and detecting such signals superimposed on power frequency voltage/current components;
ii) calculating the sectional series capacitance (Cₛ) and the sectional ground capacitance (C_{g}) of each of the different sections n of the winding using the values of I₁, I₂ and V₁ obtained above and the value of bushing capacitance C_{b} provided by the transformer manufacturer as follows:

$$I = {I}_{1} - ω {C}_{b} {V}_{1}$$

$$N = {[ \begin{matrix}\frac{I}{{I}_{2}} & \frac{ω {V}_{1}}{{I}_{2}} \\ \frac{( {I}^{2} - {I}_{2}^{2} )}{ω {V}_{1} {I}_{2}} & \frac{I}{{I}_{2}}\end{matrix} ]}^{\frac{1}{n}}$$

$${C}_{s} = \frac{1}{N ( 1 , 2 )}$$

$${C}_{g} = 2 [ {C}_{s} N ( 1 , 1 ) - {C}_{s} ]$$

where ω is the selected high frequency in rad/sec,
n is number of sections,
N is 2×2 matrix obtained from measurements above and N(1,1) and N(1,2) are the first and second element of row one of matrix N,
V₁ is constant sinusoidal voltage applied in volts, and
I₁ and I₂ are two terminal currents in amperes
(iii) simulating a range of deformations in each of the sections of the winding by changing the sectional ground capacitance C_{g} and sectional series capacitance Cₛ obtained above by predetermined percentages and generating simulated terminal current values I₁¹ and I₂¹ under the same conditions and procedures corresponding to I₁ and I₂, respectively as above for each change of the sectional ground capacitance and sectional series capacitance;
(iv) calculating current deviation coefficient which is a non-limiting function of (I₁−I₁¹)/(I₂−I₂¹) for each of the sections of the winding for each change of the sectional ground capacitance C_{g} and the sectional series capacitance Cₛ obtained above to form a first look up table of current deviation coefficients; and forming a first set of finger print values using the current deviation coefficients, the first set of finger print values indicating the location of the deformed section of the winding and the type of deformation; and
(v) generating a second set of finger print values by calculating the difference between I₁ and I₁¹ obtained above and between I₂ and I₂¹ obtained above for each of the sections of the winding for each change of the sectional ground capacitance C_{g} and the sectional series capacitance Cₛ obtained above; forming a second lookup table of differences and forming a second set of finger print values using the differences, the second set of fingerprint values indicating the extent of deformation of the deformed section.

The location and extent of radial or axial deformation or combination of both radial and axial deformation in the winding is determined by
(i) measuring the terminal current values I₁¹¹ and I₂¹¹ as explained above at the same high frequency voltage V₁;
(ii) comparing the values of I₁ with I₁¹¹ and I₂ with I₂¹¹, a no difference in the values indicating no deformation in the winding and a difference in the values indicating deformation in the winding, in which case carrying out the following steps:
(a) calculating the current deviation coefficient which is a non-limiting function of (I₁−I₁¹¹)/(I₂−I₂¹¹) for identifying the section of the winding which has been deformed; comparing the calculated current deviation coefficient with the first fingerprint values of current deviation coefficients obtained above for locating the section of the winding which has been deformed, the current deviation coefficient being always negative for radial deformation of a section and being always positive for axial deformation of a section, the sign of the current deviation being an indicator of the type of deformation; the sign of current deviation coefficient for combined axial and radial deformations depending on the dominating type (axial or radial) of deformation and being located with the first set of finger print values; and
(b) calculating the difference between I₁ and I₁¹¹ and between I₂ and I₂¹¹ comparing the difference of I₁−I₁¹¹ with corresponding second set of fingerprint values of I₁−I₁¹ obtained above and also the difference of I₂−I₂¹¹ with the corresponding second set of fingerprint values of I₂−I₂¹ obtained above for the located section obtained above to give the extent of axial and radial deformation.

The change in the capacitance of the bushing of the transformer connected at the line end of the winding is determined by
(i) measuring the terminal current values I₁¹¹¹ and I₂¹¹¹ as stated above at the same high frequency voltage V₁;
(ii) comparing the values of I₁ with I₁¹¹¹ and I₂ with I₂¹¹¹; a no difference in the values of I₂ and I₂¹¹¹ and a difference between I₁ and I₁¹¹¹ indicating no deformation in the winding but a change in the bushing capacitance;
(iii) and if necessary determining the change in the bushing capacitance by finding out the difference between I₁ and I₁¹¹¹ and dividing the difference by ω V₁ to give the change in capacitance of the bushing.

The state of the insulation system of the transformer is determined by detecting partial discharge pulses in the transformer winding by
(a)
(i) switching off the high frequency signal and measuring and analyzing the current variation of the partial discharge pulses seen at line terminal of the winding and at the other terminal of the winding to get signals I₁¹¹¹¹ and I₂¹¹¹¹ by digitally filtering signals with the band pass filter whose frequency band is the same as the frequency band in which transformer winding behaves as capacitive network as stated above; and
(ii) determining the ratio of I₁¹¹¹¹/I₂¹¹¹¹ to give the location of partial discharge pulses, a ratio greater than one indicating the location of partial discharge towards the line end of the winding, a ratio near or close to one, indicating the location of partial discharge near or close to the center of the winding and a ratio less than one indicating the location of partial discharge towards the other end of the winding; and
(b)
by detecting change in the dielectric characteristics of the insulation system of the transformer by
(i) measuring the θ₁¹¹ as described above at the same high frequency voltage V₁; and
(ii) comparing the values of θ₁ and θ₁¹¹, substantial change in the values indicating change in the dielectric characteristics of the insulation system.

In the case of the three phase star connected windings of the transformer as illustrated in FIG. 3 of the accompanying drawings, the various health factors of each of the phase windings are determined on-line as described above.

In the case of a three phase delta connected transformer of FIG. 4 of the accompanying drawings, on-line measurement of health factors of the transformer according to the invention are carried out by
1) representing the three phase windings as P1, P2 and P3 and further representing one of the phase windings PI as a lumped parameter circuit and dividing the phase winding P1 into at least two sections n;
2) generating a first set of fingerprint values by

(i) shorting under off-line condition both the ends of the phase winding P2 and connecting the shorted ends of the phase winding P2 to the ground terminal, measuring the injected high frequency terminal current I₃ at one end of the phase winding P1 when a constant sinusoidal voltage V₁ is applied between the said one end of the phase winding P1 and the ground terminal and measuring the high frequency terminal current I₄ between the shorted ends of the phase windings P2 and the ground terminal and disconnecting the short circuited ends of the phase winding P2; the high frequency is selected only once in a band of frequencies at which the terminal impedance of the winding remains capacitive;

(ii) measuring the high frequency terminal current I₁ at said one end of the phase winding P1 and current I₂ at other end of the phase winding P1 when a constant sinusoidal voltage V₁ is applied through coupling capacitors between one ends of the phase windings P1, P2 and P3 and ground terminal at the same high frequency, measuring the phase angle θ₁ between I₁ and V₁, the injection of high frequency current along with power line current being carried out by employing known procedures of coupling and detecting such signals superimposed on power frequency voltage/current components;

(iii) calculating the sectional series capacitance (Cₛ) and the sectional ground capacitance (C_{g}) of each of the sections n of the phase windings P1 using the values of I₃ and I₄ obtained above and the value of bushing capacitance C_{b} provided by the transformer manufactured as follows:

$$I = {I}_{3} - ω {C}_{b} {V}_{1}$$

$$N = {[ \begin{matrix}\frac{I}{{I}_{4}} & \frac{ω {V}_{1}}{{I}_{4}} \\ \frac{( {I}^{2} - {I}_{4}^{2} )}{ω {V}_{1} {I}_{4}} & \frac{I}{{I}_{4}}\end{matrix} ]}^{\frac{1}{n}}$$

$${C}_{s} = \frac{1}{2 N ( 1 , 2 )}$$

$${C}_{g} = 2 [ {C}_{s} N ( 1 , 1 ) - {C}_{s} ]$$

where ω is selected high frequency in rad/sec,
   n is number of sections,
   N is 2×2 matrix obtained from measurements stated above and N(1,1) and N(1,2) are the first and second element of row one of matrix N,
   V₁ is constant sinusoidal voltage applied in volts and
   I₃ and I₄ are two terminal current in amperes

(iv) simulating a range of deformations in each of the sections n of phase winding P1 by changing the sectional ground capacitance C_{g} and sectional series capacitance Cₛ obtained above by predetermined percentages and generating simulated terminal current values I₁¹ and I₂¹ under the same conditions and procedures corresponding to I₁ and I₂, respectively as stated above for each change of the sectional ground capacitance and sectional series capacitance.

(v) calculating current deviation coefficient which is a non-limiting function of (I₁−I₁¹)/(I₂−I₂¹) for each of the sections of the winding for each change of the sectional ground capacitance C_{g} obtained above and the sectional series capacitance Cₛ obtained above; and forming a first set of finger prints values using lookup table of the current deviation coefficients, and

(vi) calculating the difference (I₁−I₁¹) between I₁ obtained above and I₁¹ obtained above and also the difference (I₂−I₂¹) between I₂ obtained above and I₂¹ obtained above for each of the sections of the phase winding P1 for each change of the sectional ground capacitance C_{g} and the sectional series capacitance Cₛ obtained above, forming a second set of fingerprint values using the lookup table of the current differences, the second set of fingerprint values indicating the extent of deformation of the deformed section; and
3) representing each of the phase windings P2 and P3 as a lumped parameter circuit and dividing each of the phase windings P2 and P3 into at least two sections n and generating a first set of finger print values and a second set of finger print values for each of the remaining phase windings P2 and P3 as described above, shorting of the ends of phase winding P3 is done for off-line measurement of phase winding P2 and shorting of the ends of phase winding P1 is done for off-line measurement of phase winding P3.
4) determining the location and extent of radial and/or axial deformation in the phase winding P1 by
   (i) measuring the terminal current values I₁¹¹ and I₂¹¹ as explained above at the same high frequency voltage V₁;
   (ii) comparing the values of I₁ with I₁¹¹ and I₂ with I₂¹¹, a no difference in the values indicating no deformation in the winding and a difference in the values indicating deformation in the winding, in which case carrying out the following further steps:
   (a) calculating the current deviation coefficient which is a non-limiting function of (I₁−I₁¹¹)/(I₂−I₂¹¹) for identifying the section of the winding which has been deformed; comparing the calculated current deviation coefficient with the first fingerprint values of current deviation coefficients obtained above for locating the section of the winding which has been deformed, the current deviation coefficient being always positive for radial deformation of a section and being always negative for axial deformation of a section, the sign of the current deviation being an indicator of the type of deformation; the sign of current deviation coefficient for combined axial and radial deformations depending on the dominating type (axial or radial) of deformation and being located with the first of finger print values obtained above;
   (b) calculating the difference between I₁ and I₁¹¹ and between I₂ and I₂¹¹; comparing the difference of I₁−I₁¹¹ with the corresponding second set of fingerprint values of I₁−I₁¹ obtained above and also the difference of I₂−I₂¹¹ with the corresponding second set of fingerprint values of I₂−I₂¹ obtained above for the located section to give the extent of deformation;
5) repeating the above procedure for determining the location and extent of radial and/or axial deformation in the other phase windings P2 and P3;
6) determining the change in the capacitance of the bushing of the transformer connected at the line end of each of the phase windings P1, P2 and P3 by
   (i) measuring the terminal current values I₁¹¹¹ and I₂¹¹¹ as stated above at the same high frequency voltage V₁;
   (ii) comparing the values of I₁ with I₁¹¹¹ and I₂ with I₂¹¹¹; a no difference in the values of I₂ and I₂¹¹¹ and a difference between I₁ and I₁¹¹¹ indicating no deformation in the winding but a change in the bushing capacitance;
   (iii) and if necessary determining the change in the bushing capacitance by finding out the difference between I₁ and I₁¹¹¹ and dividing the difference by ω V₁ to give the change in capacitance of the bushing; and
7) determining the state of the insulation system of the transformer:

(a) by detecting partial discharge pulses in each of the phase windings P1, P2 and P3 by
(i) switching off the high frequency signal and measuring and analyzing the current variation of the partial discharge pulses seen at line terminal of the phase winding and at the other terminal of the phase winding to get signals I₁¹¹¹¹ and I₂¹¹¹¹ by digitally filtering signals with the band pass filter whose frequency band is the same as the frequency band in which transformer winding behaves as capacitive network as stated above; and
(ii) determining the ratio of I₁¹¹¹¹/I₂¹¹¹¹ to give the location of partial discharge pulses, a ratio greater than one indicating the location of partial discharge towards the line end of the winding, a ratio near or close to one, indicating the location of partial discharge near or close to the center of the phase winding and a ratio less than one indicating the location of partial discharge towards the other end of the phase winding; and

(b) by detecting change in the dielectric characteristics of the insulation system of the transformer by
(i) measuring the θ₁¹¹ as described above at the same high frequency voltage V₁; and
(ii) comparing the values of θ₁ and θ₁¹¹, a substantial change in the values indicating change in the dielectric characteristics of the insulation system.

According to the invention, the on-line diagnostic method continuously monitors multiple health factors of the transformer in service condition without having to isolate the transformer from the power system in which it is connected so as to give a comprehensive health status of the transformer. It is accurate and reliable and effective in determining health factors of the transformer. It eliminates the down time required for the diagnosis of the health condition of the transformer. It helps to understand the dynamic behaviour of the transformer subjected to short circuit as the measurement is done on-line. It is also simple and easy to carry out and is economical and user friendly as it is based on a few terminal measurements and is deskilled as no expertise is required to deduce diagnostic conclusions.

The above embodiment of the invention is by way of example and should not be construed and understood to be limiting the scope of the invention. Several variations of the invention obvious to those skilled in the art and falling within the scope of the invention are possible. The transformer winding may be divided into non-uniform sections. The deformations in the transformer winding may be determined for multiple sections of the winding. The location and extent of deformation may be determined for any current carrying coil besides transformer winding. The on-line method also can be used to measure or monitor health factors of both the HV and LV windings of the transformer simultaneously. Such variations of the invention are obvious to those skilled in the art and are to be construed and understood to be within the scope of the invention.

1) An on-line diagnostic method for health monitoring of a single phase transformer or a three phase star connected transformer, the method comprising the following steps:
A) determining deformations in the transformer winding by
A-1) representing the transformer winding as a lumped parameter circuit and dividing the winding into at least two sections n;
A-2) generating a first set of fingerprint values by
(i) measuring the high frequency terminal current I₁ at one end of the winding when a constant sinusoidal voltage V₁ is applied between one end of the winding and one ground terminal at a high frequency in a band of frequencies at which the terminal impedance of the winding remains capacitive, while keeping the other end of the winding and the other ground terminal connected; measuring the high frequency terminal current I₂ flowing from other end of the winding to the other ground terminal at the same high frequency, while keeping the same voltage V₁ between one end of the winding and the one ground terminal; and measuring the phase angle θ₁ between I₁ and V₁, the application of high frequency voltage and detection of high frequency currents being carried out by employing known procedures of coupling and detecting such signals superimposed on power frequency voltage/current components;
ii) calculating the sectional series capacitance (Cₛ) and the sectional ground capacitance (C_{g}) of each of the different sections n of the winding using the values of I₁, I₂ and V₁ obtained in step A-2(i) and the value of bushing capacitance C_{b} provided by the transformer manufacturer as follows:
$$I = {I}_{1} - ω {C}_{b} {V}_{1}$$
$$N = {[ \begin{matrix}\frac{I}{{I}_{2}} & \frac{ω {V}_{1}}{{I}_{2}} \\ \frac{( {I}^{2} - {I}_{2}^{2} )}{ω {V}_{1} {I}_{2}} & \frac{I}{{I}_{2}}\end{matrix} ]}^{\frac{1}{n}}$$
$${C}_{s} = \frac{1}{N ( 1 , 2 )}$$
$${C}_{g} = 2 [ {C}_{s} N ( 1 , 1 ) - {C}_{s} ]$$
where ω is the selected high frequency in rad/sec,
n is number of sections,
N is 2×2 matrix obtained from measurements in step A-2(i) and
N(1,1) and N(1,2) are the first and second element of row one of matrix N,
V₁ is constant sinusoidal voltage applied in volts, and
I₁ and I₂ are two terminal currents in amperes
(iii) simulating a range of deformations in each of the sections of the winding by changing the sectional ground capacitance C_{g} and sectional series capacitance Cₛ obtained in step A-2(ii) by predetermined percentages and generating simulated terminal current values I₁¹ and I₂¹ under the same conditions and procedures corresponding to I₁ and I₂, respectively in step A-2(i) for each change of the sectional ground capacitance and sectional series capacitance;
(iv) calculating current deviation coefficient which is a non-limiting function of (I₁−I₁¹)/(I₂−I₂¹) for each of the sections of the winding for each change of the sectional ground capacitance C_{g} and the sectional series capacitance Cₛ obtained in step A-2(iii) to form a first look up table of current deviation coefficients; and forming a first set of finger print values using the current deviation coefficients, the first set of finger print values indicating the location of the deformed section of the winding and the type of deformation;
A-3) generating a second set of finger print values by calculating the difference between I₁ obtained in step A-2(i) and I₁¹ obtained in step A-2(iii) and between I₂ obtained in step A-2 (i) and I₂¹ obtained in step A-2 (iii) for each of the sections of the winding for each change of the sectional ground capacitance C_{g} and the sectional series capacitance Cₛ obtained in step A-2 (iii); forming a second lookup table of differences and forming a second set of finger print values using the differences, the second set of fingerprint values indicating the extent of deformation of the deformed section; and
A-4) determining the location and extent of radial or axial deformation or combination of both radial and axial deformation in the winding by
(i) measuring the terminal current values I₁¹¹ and I₂¹¹ as explained in step A-2(i) at the same high frequency voltage V₁;
(ii) comparing the values of I₁ with I₁¹¹ and I₂ with I₂¹¹, a no difference in the values indicating no deformation in the winding and a difference in the values indicating deformation in the winding, in which case carrying out the following steps:
(a) calculating the current deviation coefficient which is a non-limiting function of (I₁−I₁¹¹)/(I₂−I₂¹¹) for identifying the section of the winding which has been deformed; comparing the calculated current deviation coefficient with the first fingerprint values of current deviation coefficients obtained in step A-2(iv) for locating the section of the winding which has been deformed, the current deviation coefficient being always negative for radial deformation of a section and being always positive for axial deformation of a section, the sign of the current deviation being an indicator of the type of deformation; the sign of current deviation coefficient for combined axial and radial deformations depending on the dominating type (axial or radial) of deformation and being located with the first set of finger print values obtained in step A-2(iv).
(b) calculating the difference between I₁ and I₁¹¹ and between I₂ and I₂¹¹; comparing the difference of I₁−I₁¹¹ with the corresponding second set of fingerprint values of I₁−I₁¹ obtained in step A-3 and also the difference of I₂−I₂¹¹ with the corresponding second set of fingerprint values of I₂−I₂¹ obtained in step A-3 for the located section in step A-4(ii)(a) to give the extent of axial and radial deformation;
B) determining the change in the capacitance of the bushing of the transformer connected at the line end of the winding by
(i) measuring the terminal current values I₁¹¹¹ and I₂¹¹¹ as stated in step A-2(i) at the same high frequency voltage V₁;
(ii) comparing the values of I₁ with I₁¹¹¹ and I₂ with I₂¹¹¹; a no difference in the values of I₂ and I₂¹¹¹ and a difference between I₁ and I₁¹¹¹ indicating no deformation in the winding but a change in the bushing capacitance;
(iii) and if necessary determining the change in the bushing capacitance by finding out the difference between I₁ and I₁¹¹¹ and dividing the difference by ω V₁ to give the change in capacitance of the bushing; and
C) determining the state of the insulation system of the transformer by detecting partial discharge pulses in the transformer winding by
(a)
(i) switching off the high frequency signal and measuring and analyzing the current variation of the partial discharge pulses seen at line terminal of the winding and at the other terminal of the winding to get signals I₁¹¹¹¹ and I₂¹¹¹¹ by digitally filtering signals with the band pass filter whose frequency band is the same as the frequency band in which transformer winding behaves as capacitive network as stated in A-2(i); and
(ii) determining the ratio of I₁¹¹¹¹/I₂¹¹¹¹ to give the location of partial discharge pulses, a ratio greater than one indicating the location of partial discharge towards the line end of the winding, a ratio near or close to one, indicating the location of partial discharge near or close to the center of the winding and a ratio less than one indicating the location of partial discharge towards the other end of the winding; and
(b)
by detecting change in the dielectric characteristics of the insulation system of the transformer by
(i) measuring the θ₁¹¹ as described in step A-2(i) at the same high frequency voltage V₁; and
(ii) comparing the values of θ₁ obtained in step A-2(i) and θ₁¹¹ obtained in step C(b)(i), a substantial change in the values indicating change in the dielectric characteristics of the insulation system.

2. An on-line diagnostic method for health monitoring of a three phase delta connected transformer, the method comprising the following steps:
D) representing the three phase windings as P1, P2 and P3 and further representing one of the phase windings P1 as a lumped parameter circuit and dividing the phase winding P1 into at least two sections n;
E) generating a first set of fingerprint values by
(i) shorting under off-line condition both the ends of the phase winding P2 and connecting the shorted ends of the phase winding P2 to the ground terminal, measuring the injected high frequency terminal current I₃ at one end of the phase winding P1 when a constant sinusoidal voltage V₁ is applied between the said one end of the phase winding P1 and the ground terminal and measuring the high frequency terminal current I₄ between the shorted ends of the phase windings P2 and the ground terminal and disconnecting the short circuited ends of the phase winding P2; the high frequency being selected only once in a band of frequencies at which the terminal impedance of the winding remains capacitive;
(ii) measuring the high frequency terminal current I₁ at said one end of the phase winding P1 and current I₂ at other end of the phase winding P1 when a constant sinusoidal voltage V₁ is applied through coupling capacitors between one ends of the phase windings P1, P2 and P3 and ground terminal at the same high frequency, measuring the phase angle θ₁ between I₁ and V₁, the injection of high frequency current along with power line current being carried out by employing known procedures of coupling and detecting such signals superimposed on power frequency voltage/current components;
(iii) calculating the sectional series capacitance (Cₛ) and the sectional ground capacitance (C_{g}) of each of the sections n of the phase windings P1 using the values of I₃ and I₄ obtained in step E(i) and the value of bushing capacitance C_{b} provided by the transformer manufacturer as follows:
$$I = {I}_{3} - ω {C}_{b} {V}_{1}$$
$$N = {[ \begin{matrix}\frac{I}{{I}_{4}} & \frac{ω {V}_{1}}{{I}_{4}} \\ \frac{( {I}^{2} - {I}_{4}^{2} )}{ω {V}_{1} {I}_{4}} & \frac{I}{{I}_{4}}\end{matrix} ]}^{\frac{1}{n}}$$
$${C}_{s} = \frac{1}{2 N ( 1 , 2 )}$$
$${C}_{g} = 2 [ {C}_{s} N ( 1 , 1 ) - {C}_{s} ]$$
where ω is selected high frequency in rad/sec,
n is number of sections,
N is 2×2 matrix obtained from measurements in step E(i) and N(1,1) and N(1,2) are the first and second element of row one of matrix N,
V₁ is constant sinusoidal voltage applied in volts and
I₃ and I₄ are two terminal current in amperes
(iv) simulating a range of deformations in each of the sections n of phase winding P1 by changing the sectional ground capacitance C_{g} and sectional series capacitance Cₛ obtained in step E(iii) by predetermined percentages and generating simulated terminal current values I₁¹ and I₂¹ under the same conditions and procedures corresponding to I₁ and I₂, respectively in step E(ii) for each change of the sectional ground capacitance and sectional series capacitance;
(v) calculating current deviation coefficient which is a non-limiting function of (I_{I}−I₁¹)/(I₂−I₂¹) for each of the sections of the winding for each change of the sectional ground capacitance C_{g} obtained in step E(iii) and the sectional series capacitance Cₛ obtained in step E(iii); and forming a first set of finger print values using lookup table of the current deviation coefficients; and
(vi) calculating the difference (I₁−I₁¹) between I₁ obtained in step E(ii) and I₁¹ obtained in step E(iv) and also the difference (I₂−I₂¹) between I₂ obtained in step E(ii) and I₂′ obtained in step E(iv) for each of the sections of the phase winding P1 for each change of the sectional ground capacitance C_{g} and the sectional series capacitance Cₛ obtained in step E(iii) and forming a second set of fingerprint values using the lookup table of the current differences, the second set of fingerprint values indicating the extent of deformation of the deformed section; and
F. representing each of the phase windings P2 and P3 as a lumped parameter circuit and dividing each of the phase windings P2 and P3 into at least two sections n and generating a first set of finger print values and a second set of finger print values for each of the remaining phase windings P2 and P3 as described in step (E), shorting of the ends of phase winding P3 is done for off-line measurement of phase winding P2 and shorting of the ends of phase winding P1 is done for off-line measurement of phase winding P3;
G) determining the location and extent of radial and/or axial deformation in the phase winding P1 by
(i) measuring the terminal current values I₁¹¹ and I₂¹¹ as explained in step E(ii) at the same high frequency voltage V₁;
(ii) comparing the values of I₁ with I₁¹¹ and I₂ with I₂¹¹, a no difference in the values indicating no deformation in the winding and a difference in the values indicating deformation in the winding, in which case carrying out the following further steps:
(a) calculating the current deviation coefficient which is a non-limiting function of (I₁−I₁¹¹)/(I₂−I₂¹¹) for identifying the section of the winding which has been deformed; comparing the calculated current deviation coefficient with the first fingerprint values of current deviation coefficients obtained in step E(v) for locating the section of the winding which has been deformed, the current deviation coefficient being always positive for radial deformation of a section and being always negative for axial deformation of a section, the sign of the current deviation being an indicator of the type of deformation; the sign of current deviation coefficient for combined axial and radial deformations depending on the dominating type (axial or radial) of deformation and being located with the first of finger print values obtained in step E(v);
(b) calculating the difference between I₁ and I₁¹¹ and between I₂ and I₂¹¹; comparing the difference of I₁−I₁¹¹ with the corresponding second set of fingerprint values of I₁−I₁¹ obtained in step E(vi) and also the difference of I₂−I₂¹¹ with the corresponding second set of fingerprint values of I₂−I₂¹ obtained in step E(vi) for the located section in step G(ii)(a) to give the extent of deformation;
H) repeating the above procedure for determining the location and extent of radial and/or axial deformation in the other phase windings P2 and P3;
I) determining the change in the capacitance of the bushing of the transformer connected at the line end of each of the phase windings P1, P2 and P3 by
(i) measuring the terminal current values I₁¹¹¹ and I₂¹¹¹ as stated in step E(ii) at the same high frequency voltage V₁;
(ii) comparing the values of I₁ with I₁¹¹¹ and I₂ with I₂¹¹¹; a no difference in the values of I₂ and I₂¹¹¹ and a difference between I₁ and I₁¹¹¹ indicating no deformation in the winding but a change in the bushing capacitance;
(iii) and if necessary determining the change in the bushing capacitance by finding out the difference between I₁ and I₁¹¹¹ and dividing the difference by ω V₁ to give the change in capacitance of the bushing; and
J) determining the state of the insulation system of the transformer:
(a) by detecting partial discharge pulses in each of the phase windings P1, P2 and P3 by
(i) switching off the high frequency signal and measuring and analyzing the current variation of the partial discharge pulses seen at line terminal of the phase winding and at the other terminal of the phase winding to get signals I₁¹¹¹¹ and I₂¹¹¹¹ by digitally filtering signals with the band pass filter whose frequency band is the same as the frequency band in which transformer winding behaves as capacitive network as stated in step E(i); and
(ii) determining the ratio of I₁¹¹¹¹/I₂¹¹¹¹ to give the location of partial discharge pulses, a ratio greater than one indicating the location of partial discharge towards the line end of the winding, a ratio near or close to one, indicating the location of partial discharge near or close to the center of the phase winding and a ratio less than one indicating the location of partial discharge towards the other end of the phase winding; and
(b) by detecting change in the dielectric characteristics of the insulation system of the transformer by
(i) measuring the θ₁¹¹ as described in step E(ii) at the same high frequency voltage V₁; and
(ii) comparing the values of θ₁ in step E(ii) and θ₁¹¹ in step J(b)(i), a substantial change in the values indicating change in the dielectric characteristics of the insulation system.
